(19) United States
(12) Patent Application Publication
(10) Pub. No.: US 2011/0138462 A1
(43) Pub. Date: Jun. 9, 2011

(54) SYSTEM AND METHOD FOR DETECTING VOIP TOLL FRAUD ATTACK FOR INTERNET TELEPHONE

(76) Inventors: Jeong-Wook Kim, Gyeonggi-do (KR); Hwan-Kuk Kim, Seoul (KR); Hyun-Cheol Jeong, Seoul (KR); Yoo-Jae Won, Seoul (KR); Seok-Ung Yoon, Gyeonggi-do (KR); Jong-II Jeong, Gyeonggi-do (KR); Kyoung-Hee Ko, Incheon (KR)

(21) Appl. No.: 12/646,174

(22) Filed: Dec. 23, 2009

(30) Foreign Application Priority Data
Dec. 9, 2009 (KR) 10-2009-0121936

(51) Int. Cl. G06F 11/00

(52) U.S. Cl. 726/22

(57) ABSTRACT

Provided is a system for detecting a voice over Internet protocol (VoIP) toll fraud attack. The system includes: a database (DB) storing registration information of normal users; a packet reception module receiving a call set-up packet from a network; and a VoIP signaling message forgery/falsification detection module receiving the call set-up packet from the packet reception module and comparing sender address information or header information of the call set-up packet with the registration information stored in the DB to detect whether the call set-up packet is a packet received from one of the normal users.

### RELATED APPLICATION

This application claims priority from Korean Patent Application No. 10-2009-0121936 filed on Dec. 9, 2009, the disclosure of which is incorporated herein by reference in its entirety.

### BACKGROUND

1. Field of Disclosure

The present invention relates to a system for detecting a voice over Internet protocol (VoIP) attack, and more particularly, to a system for detecting a VoIP toll fraud attack.

2. Description of Related Technology

The rapid development of information and communication technology has led to popularization of Internet telephones. In Internet telephony, a session initiation protocol (SIP) packet is often used to set up a call between a calling party and a called party. An SIP packet contains address information of a calling party and a called party as well as various information needed to set up a call, and a call is set up by sending or receiving this SIP packet.

However, conventional security equipment is vulnerable to hacking attacks using a packet related to an application layer, such as an SIP packet. Therefore, malicious users often charge their fraudulent voice over Internet protocol (VoIP) calls to authorized users (victims). Accordingly, it is urgently needed to develop a security system that can detect hacking attacks using a packet related to an application layer, such as an SIP packet, and block the hacking attacks.

### SUMMARY

Aspects of the present invention provide a system for detecting a voice over Internet protocol (VoIP) toll fraud attack.

Aspects of the present invention also provide a method of detecting a VoIP toll fraud attack.

However, aspects of the present invention are not restricted to the one set forth herein. The above and other aspects of the present invention will become more apparent to one of ordinary skill in the art to which the present invention pertains by referencing the detailed description of the present invention given below.

According to an aspect of the present invention, there is provided a system for detecting a VoIP toll fraud attack. The system includes: a database (DB) storing registration information of normal users; a packet reception module receiving a call set-up packet from a network; and a VoIP signaling message forgery/falsification detection module receiving the call set-up packet from the packet reception module and comparing sender address information or header information of the call set-up packet with the registration information stored in the DB to detect whether the call set-up packet is a packet received from one of the normal users.

According to another aspect of the present invention, there is provided a method of detecting a VoIP toll fraud attack. The method includes: receiving a call set-up packet from a network; filtering the call set-up packet based on sender address information or header information of the received call set-up packet; and comparing the sender address information or the header information of the received call set-up packet with registration information of normal users to detect whether the call set-up packet is a packet received from one of the normal users.

### BRIEF DESCRIPTION OF THE DRAWINGS

The above and other aspects and features of the present invention will become more apparent by describing in detail exemplary embodiments thereof with reference to the attached drawings, in which:

FIG. 1 illustrates the configuration of a system for detecting a voice over Internet protocol (VoIP) toll fraud attack according to an exemplary embodiment of the present invention;

FIG. 2 illustrates an example of a session initiation protocol (SIP) packet including a register method;

FIG. 3 illustrates a process of receiving registration information of a normal user;

FIG. 4 is a flowchart illustrating the operation of a VoIP signaling message forgery/falsification detection module included in the system of FIG. 1; and

FIG. 5 is a flowchart illustrating a method of detecting a VoIP toll fraud attack according to an exemplary embodiment of the present invention.

### DETAILED DESCRIPTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims Like reference numerals refer to like elements throughout the specification. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “made of,” when used in this specification, specify the presence of stated components, steps, operations, and/or elements, but do not preclude the presence or addition of one or more other components, steps, operations, elements, and/or groups thereof.

Embodiments of the invention are described herein with reference to (configuration diagrams and) flowchart illustrations that are schematic illustrations of idealized embodiments of the invention. As such, variations from the shapes of the illustrations as a result, for example, of manufacturing techniques and/or tolerances, are to be expected. Thus, embodiments of the invention should not be construed as limited to the particular shapes of elements illustrated herein but are to include deviations in shapes that result, for example, from manufacturing. Thus, the elements illustrated in the figures are schematic in nature and their shapes are not intended to illustrate the actual shape of an element of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Throughout the specification, a call set-up packet will be described using a session initiation protocol (SIP) packet as an example. However, the call set-up packet is not limited to the SIP packet.

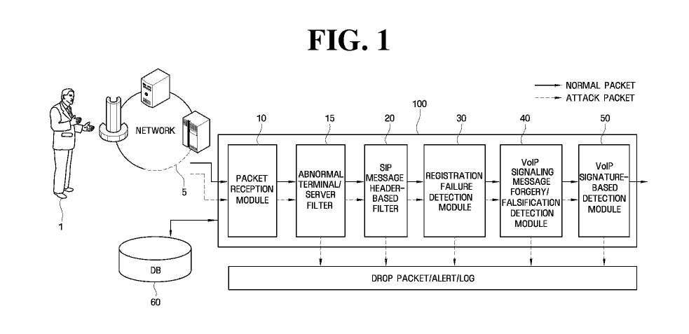

Hereinafter, a system for detecting a voice over Internet protocol (VoIP) toll fraud attack according to an exemplary embodiment of the present invention will be described with reference to FIGS. 1 through 4.

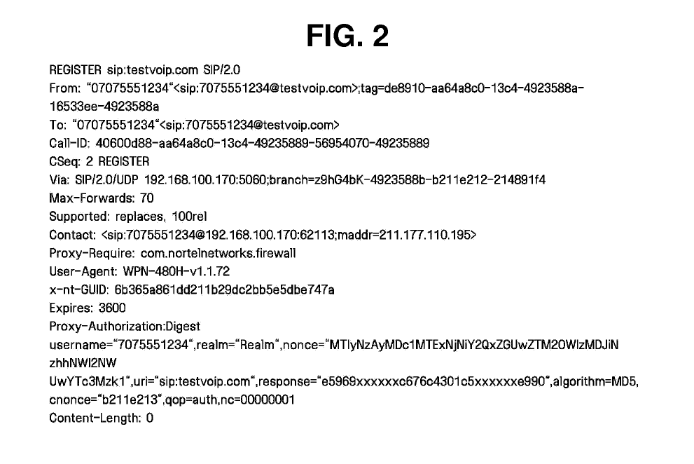

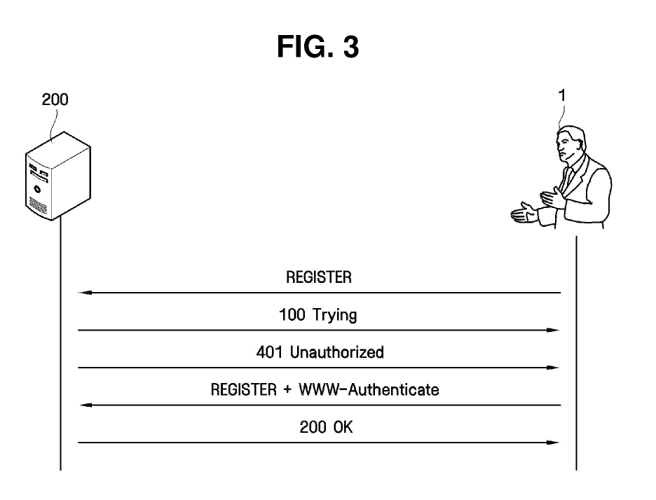

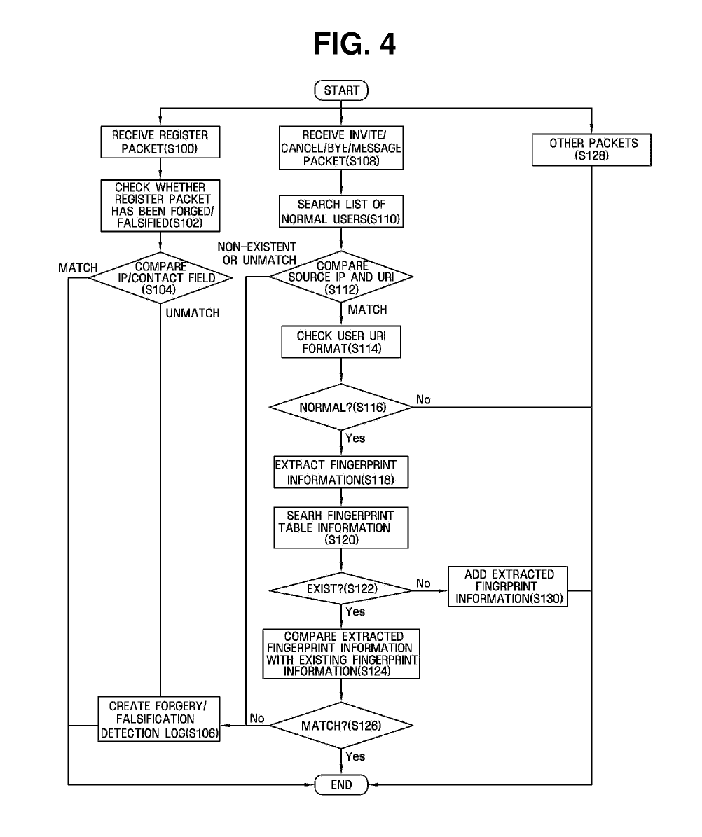

FIG. 1 illustrates the configuration of a system 100 for detecting a VoIP toll fraud attack according to an exemplary embodiment of the present invention. FIG. 2 illustrates an example of an SIP packet including a register method. FIG. 3 illustrates a process of receiving registration information of a normal user. FIG. 4 is a flowchart illustrating the operation of a VoIP signaling message forgery/falsification detection module 40 included in the system 100 of FIG. 1.

Referring to FIG. 1, the system 100 for detecting a VoIP toll fraud attack according to the current exemplary embodiment may include a packet reception module 10, an abnormal terminal/server filter 15, an SIP message header-based filter 20, a registration failure detection module 30, the VoIP signaling message forgery/falsification detection module 30, a VoIP signature-based detection module 50, and a registration information database (DB) 60.

The packet reception module 10 may receive a call set-up packet (e.g., an SIP packet) from a network 5. Once receiving an SIP packet from the network 5, the packet reception module 10 may provide the received SIP packet to the abnormal terminal/server filter 15. The network 5 of the system 100 for detecting a VoIP toll fraud attack according to the current exemplary embodiment may be, but is not limited to, a VoIP service network that can provide a VoIP service to a user 1.

The abnormal terminal/server filter 15 may filter an SIP packet based on sender address information of the SIP packet. Specifically, the abnormal terminal/server filter 15 may analyze an SIP packet received from the packet reception module 10 and extract sender address information of the SIP packet. Then, the abnormal terminal/server filter 15 may compare the extracted sender address information with address information of normal users which is stored in the registration information DB 60. When determining that the sender of the SIP packet is a malicious user whose address information is not stored in the registration information DB 60, the abnormal terminal/server filter 15 may drop the SIP packet, alert an administrator, and log relevant information. That is, the abnormal terminal/server filter 15 performs the function of blocking calls from abnormal terminals or SIP servers. In the system 100 for detecting a VoIP toll fraud attack according to the current exemplary embodiment, the sender address information of an SIP packet may be, but is not limited to, an Internet protocol (IP) address or a uniform resource identifier (URI).

The SIP message header-based filter 20 may filter an SIP packet based on header information of the SIP packet. Specifically, the SIP message header-based filter 20 may analyze an SIP packet received from the abnormal terminal/server filter 15 and extract various header information of the SIP packet. Then, the SIP message header-based filter 20 may compare the extracted header information with various header information which is related to malicious users and stored in the registration information DB 60. When determining that the sender of the SIP packet is a malicious user whose header information is stored in the registration information DB 60, the SIP message header-based filter 20 may drop the SIP packet, alert the administrator, and log relevant information. That is, the SIP message header-based filter 20 may perform the function of blocking calls from known attackers.

When an SIP packet including a register method fails to be registered more than a predetermined number of times for a predetermined period of time, the registration failure detection module 30 may detect the SIP packet as an attack packet. Specifically, the registration failure detection module 30 may analyze an SIP packet received from the SIP message header-based filter 20 and, when the SIP packet is a registration packet that includes a register method, may detect the number of times that the SIP fails to be registered for a predetermined period of time. If the number of times that the SIP packet fails to be registered exceeds a predetermined number of times, the registration failure detection module 30 may detect the SIP packet as an attack packet sent by a malicious user.

Generally, a registration packet has fields as shown in FIG. 2. When a malicious user intercepts a registration packet through hacking, the malicious user can obtain values of username, realm, nonce, uri, and the like as shown in FIG. 2. To register the registration packet, however, the malicious user needs a registration password in addition to the above values. Accordingly, the malicious user may make indiscriminate registration attempts to identify the registration password. However, since the registration failure detection module 30 detects a registration packet, which fails to be registered more than a predetermined number of times for a predetermined period of time, as an attack packet, such indiscriminate registration attempts can be prevented in advance. Like the abnormal terminal/server filter 15 and the SIP message header-based filter 20, the registration failure detection module 30 may drop a registration packet, alert the administrator, and log relevant information when detecting indiscriminate registration attempts by a malicious user.

For example, when an SIP packet fails to be registered 10 to 20 times for 5 to 10 minutes, the registration failure detection module 30 included in the system 100 according to the current exemplary embodiment may detect the SIP packet as an attack packet sent by a malicious user. However, the present invention is not limited to this example.

The VoIP signaling message forgery/falsification detection module 40 may receive an SIP packet from the registration failure detection module 30 and compare sender address information or header information of the SIP packet with registration information stored in the registration information DB 60 to detect whether the SIP packet is a packet sent by a normal user.

Specifically, the VoIP signaling message forgery/falsification detection module 40 may monitor the registration process of a normal user. When the registration process of the normal user is successfully completed, the VoIP signaling message forgery/falsification detection module 40 may store registration information of the normal user in the registration information DB 60. A normal user may register with an SIP proxy server as shown in FIG. 3. Referring to FIG. 3, when a normal user 1 sends a registration request to an SIP proxy server 200 (REGISTER), the SIP proxy server 200 demands authentication information from the user 1 (100 Trying and 401 Unauthorized). Accordingly, the user 1 sends a registration request together with the authentication information (REGISTER+WWW-Authentication). Then, the SIP proxy server 200 completes registration of the user 1 by sending a response to the user 1 (200 OK) and stores registration information of the user 1 in the registration information DB 60. The registration information of the user 1 may include, but is not limited to, IP address information, URI information, contact field information, and media access control (MAC) address information.

Referring to FIG. 4, when the VoIP signaling message forgery/falsification detection module 40 may receive an SIP packet from the registration failure detection module 30 and, if the received SIP packet includes a register method, check whether the SIP packet has been forged/falsified (operations S100 and S102). Specifically, the VoIP signaling message forgery/falsification detection module 40 may compare IP address information and contact field information of the SIP packet with registration information stored in the registration information DB 60. If the IP address information and the contact field information of the SIP packet match the registration information stored in the registration information DB 60, the VoIP signaling message forgery/falsification detection module 40 may terminate its detection operation. If not, the VoIP signaling message forgery/falsification detection module 40 may create a forgery/falsification detection log and drop the SIP packet (operations 5104 and S106).

When the SIP packet received from the registration failure detection module 30 is a packet including an INVITE, CANCEL, BYE, or MESSAGE method, the VoIP signaling message forgery/falsification detection module 40 may search a list of normal users stored in the registration information DB 60 (operations S108 and S110). The VoIP signaling message forgery/falsification detection module 40 may compare the source IP and URI of the SIP packet with the registration information stored in the registration information DB 60 (operation S112). If the source IP and URI of the SIP packet do not match the registration information stored in the registration information DB 60 or if they do not exist in the registration information DB 60, the VoIP signaling message forgery/falsification detection module 40 may create a forgery/falsification detection log (operation S106). On the other hand, if the source IP and URI of the SIP packet match the registration information stored in the registration information DB 60, the VoIP signaling message forgery/falsification detection module 40 may check an URI format of the SIP packet and, when the URI format of the SIP packet is abnormal, terminate its detection operation (operations S114 and S116). To check the URI format of the SIP packet, the VoIP signaling message forgery/falsification detection module 40 may check whether values of username and domain fields in a ‘From header’ of the SIP packet are null.

When determining that the URI format of the SIP packet is normal, the VoIP signaling message forgery/falsification detection module 40 may extract fingerprint information of the SIP packet (operation S118). Fingerprint information may denote header information of an SIP packet, and header information of an SIP packet may include values of MAC, Max-Forwards, User-Agent, Contact, and Call-ID fields in a header of the SIP packet, as well as an SIP header sequence. In particular, the system 100 according to the current exemplary embodiment may extract pattern information of the Call-ID field value. The pattern information of the Call-ID field value may be information created by combining information about whether ‘@’ is included and information about Call-ID length.

Once the fingerprint information of the SIP packet is extracted, the VoIP signaling message forgery/falsification detection module 40 may search the registration information DB 60 to find corresponding fingerprint information. If the corresponding fingerprint information is not found in the registration information DB 60, the VoIP signaling message forgery/falsification detection module 40 may determine that a sender of the SIP packet is registering for the first time and add the extracted fingerprint information of the SIP packet to the registration information DB 60 (operations S120, S122, and S130). If the corresponding fingerprint information exists in the registration information DB 60 but does not match the extracted fingerprint information, the VoIP signaling message forgery/falsification detection module 40 may determine that the SIP packet has been forged/falsified and thus create a forgery/falsification detection log and drop the SIP packet (operations S124, S126, and S106). If the corresponding fingerprint information stored in the registration DB 60 matches the extracted fingerprint information, the VoIP signaling message forgery/falsification detection module 40 may determine that the SIP packet has not been forged/falsified and thus provide the SIP packet to the VoIP signature-based detection module 50.

The VoIP signature-based detection module 50 may detect whether the SIP packet has been received from a normal user through signature pattern matching. Specifically, the VoIP signature-based detection module 50 may detect an SQL injection attack or a buffer overflow attack through signature pattern matching.

The registration DB 60 may store registration information of normal users. The various above-described registration information of normal users may be stored in the registration DB 60.

When the system 100 for detecting a VoIP toll fraud attack according to the current exemplary embodiment is used, hacking attacks using a packet related to an application layer, such as an SIP packet, can be detected. In addition, since hacking attacks can be blocked in advance, malicious users can be prevented from charging their fraudulent VoIP calls to normal users (victims) through hacking.

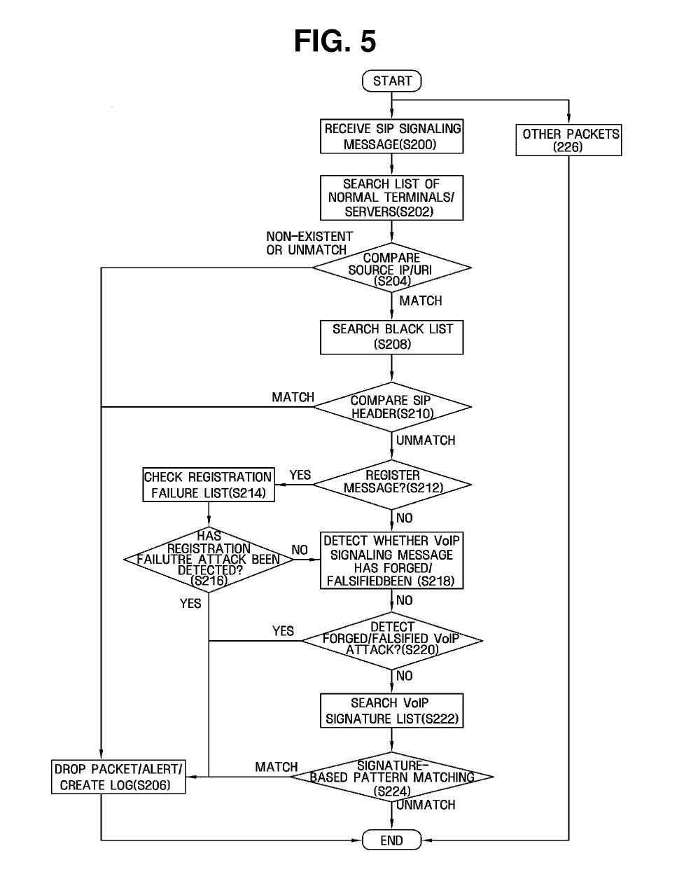

A method of detecting a VoIP toll fraud attack according to an exemplary embodiment of the present invention will now be described with reference to FIG. 5. FIG. 5 is a flowchart illustrating a method of detecting a VoIP toll fraud attack according to an exemplary embodiment of the present invention.

Referring to FIG. 5, a call set-up packet is received from a network (operations 5200 and S226). Specifically, when a call set-up packet received from a VoIP service network, which can provide a VoIP service, is an SIP packet, a detection process may be performed for the SIP packet. When the received call set-up packet is not an SIP packet, the detection process may be terminated.

Next, the received SIP packet is filtered (operations S202 through S210). Specifically, a list of normal terminals/servers is searched (operation S202), and sender address information (e.g., IP or URI information) of the received SIP packet is compared with that of the normal terminals/servers (operation S204). When the SIP packet is not a packet received from a normal terminal/server, it may be dropped (operation S206). When the SIP packet is a packet received from a normal terminal/server, header information related to known malicious users is searched (operation S208) and compared with header information of the SIP packet (operation S210). If the header information related to the known malicious users matches that of the SIP packet, the SIP packet may be dropped (operation S206).

When the received SIP packet is a packet including a register method, it is detected whether the SIP packet is a registration failure attack (operations S212 through S216). Specifically, when the received SIP packet is a packet including a register method, a registration failure list of the SIP packet is checked (operations S212 and S214) to detect whether the received SIP packet is a registration failure (operation S216). When the SIP packet including a register method fails to be registered more than a predetermined number of times for a predetermined period of time, it may be considered as an attack packet and dropped (operation S206). For example, when the SIP packet fails to be registered 10 to 20 times for 5 to 10 minutes, it may be considered as an attack packet sent by a malicious user and dropped. However, the present invention is not limited to this example.

Next, it is detected whether the received SIP packet has been forged/falsified (operations S218 through S220). Specifically, the sender address information and the header information of the received SIP packet are compared with registration information of normal users to detect whether the SIP packet has been forged/falsified (operation S218). If the SIP has been forged/falsified, it may be dropped (operations S220 and S206).

Next, it is detected whether the SIP packet is a packet sent by a normal user through signature pattern matching (operations S222 through S224). Specifically, a list of VoIP signatures is searched (operation S222). When it is determined through signature-based pattern matching that a VoIP signature of the SIP packet matches any one of the VoIP signatures, the SIP packet may be dropped (operation S206).

When the method of detecting a VoIP toll fraud attack according to the current exemplary embodiment is used, hacking attacks using a packet related to an application layer, such as an SIP packet, can be detected. In addition, since hacking attacks can be blocked in advance, malicious users can be prevented from charging their fraudulent VoIP calls to normal users (victims) through hacking.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A system for detecting a voice over Internet protocol (VoIP) toll fraud attack, the system comprising:
a database (DB) storing registration information of normal users;
a packet reception module receiving a call set-up packet from a network; and
a VoIP signaling message forgery/falsification detection module receiving the call set-up packet from the packet reception module and comparing sender address information or header information of the call set-up packet with the registration information stored in the DB to detect whether the call set-up packet is a packet received from one of the normal users.

2. The system of claim 1, wherein the network comprises a VoIP service network.

3. The system of claim 1, wherein the call set-up packet comprises a session initiation protocol (SIP) packet.

4. The system of claim 1, wherein the sender address information comprises Internet protocol (IP) address information or uniform resource identifier (URI) information of a sender of the call set-up packet.

5. The system of claim 1, wherein the header information comprises information contained in at least one of media access control (MAC), Max-Forwards, User-Agent, and Call-ID fields.

6. The system of claim 1, further comprising an abnormal terminal/server filter filtering the call set-up packet based on the sender address information of the call set-up packet.

7. The system of claim 1, further comprising an SIP message header-based filter filtering the call set-up packet based on the header information of the call set-up packet.

8. The system of claim 1, further comprising a registration failure detection module detecting the call set-up packet, which comprises a register method, as an attack packet when the call set-up packet fails to be registered more than a predetermined number of times for a predetermined period of time.

9. The system of claim 8, wherein the predetermined period of time comprises 5 to 10 minutes, and the predetermined number of times comprises 10 to 20 times.

10. The system of claim 1, further comprising a VoIP signature-based detection module detecting whether the call set-up packet is a packet received from one of the normal users through signature pattern matching.

11. A method of detecting a VoIP toll fraud attack, the method comprising:
receiving a call set-up packet from a network;
filtering the call set-up packet based on sender address information or header information of the received call set-up packet; and
comparing the sender address information or the header information of the received call set-up packet with registration information of normal users to detect whether the call set-up packet is a packet received from one of the normal users.

12. The method of claim 11, further comprising detecting the call set-up packet, which comprises a register method, as an attack packet when the call set-up packet fails to be registered more than a predetermined number of times for a predetermined period of time.

13. The method of claim 11, further comprising detecting whether the call set-up packet is a packet received from one of the normal users through signature pattern matching.
